(19) United States
(12) Patent Application Publication
(10) Pub. No.: US 2008/0277412 A1
(43) Pub. Date: Nov. 13, 2008

(54) Method and apparatus for dispensing fresh cooking oil

(75) Inventor: John W. Palazzo, Akron, OH (US)

Correspondence Address: BUCKINGHAM, DOOLITTLE & BURROUGHS, LLP, 3800 EMBASSY PARKWAY, SUITE 300, AKRON, OH, 44333-8332, US

(73) Assignee: Frontline International, Inc., Barberton, OH (US)

(21) Appl. No.: 11/423,554

(22) Filed: Jun. 12, 2006

Related U.S. Application Data
(60) Provisional application No. 60/785,727, filed on Mar. 24, 2006.

(51) Int. Cl. B67D 5/08

(52) U.S. Cl. 222/63; 222/61

(57) ABSTRACT

A new and improved method and apparatus for dispensing fresh cooking oil is herein disclosed. A fluid dispensing apparatus includes a pump, a motor, the motor operatively connected to the pump, a pressure switch having an on pressure and an off pressure, wherein the off pressure is greater than the on pressure, an expansion tank, an expandable bladder, the expandable bladder operatively connected within the expansion tank, the expandable bladder having a pressure, the pressure being set at approximately the on pressure, tubing, the tubing operatively connected to the pump, and a fluid dispenser.

This application claims priority to U.S. Ser. No. 60/785,727, filed Mar. 24, 2006, entitled Method And Apparatus For Dispensing Fresh Cooking Oil. The present invention relates to an oil dispensing device, more particularly to a cooking oil dispensing device, and even more particularly to a fresh cooking oil dispensing device.

### I. BACKGROUND OF THE INVENTION

A. Field of Invention

B. Description of the Related Art

Currently, a bulk cooling oil system has filter, waste, supply, and fryer stations connected by piping for movement of oil along preselected pipe paths. The filter station functions to filter cooking oil from the fryer station and has a valve adapted to open and close pipe lines that lead to and away from the filter station. The waste station stores used oil and has a valve adapted to open and close a pipe line leading to and away from the waste station. The supply station stores oil to be used at the fryer station for cooking food products and also has a valve adapted to open and close a pipe line leading to and away from the supply station. The fryer station has a fryer that receives and heats the cooking oil to cook food products and a valve adapted to open and close a pipe line leading to and away from the fryer station. All of the various valves are selectively operated and controlled so that a predetermined pipe path can be established between identified stations. A pump moves the oil along the selected pipe path. The existing system requires bulk oil tanks.

The present invention provides methods and apparatuses for dispensing fresh cooking oil in an automated and efficient fashion. Another advantage of this invention is that wiring is no longer needed between the pump motor and the dispensing wand or nozzle. The invention described herein uses pressurized lines and controls to cycle the pump on and off, thus offering a more reliable, safe, and easy system to install and maintain. Another advantage of the present invention is that installation is quicker and more flexible, and the present invention is generally not hindered by space or size limitations. The present invention allows the user to work with smaller oil containers and the user has the safety and efficiency of fresh oil, but is not required to commit to bulk oil purchasing. The difficulties inherit in the art are therefore overcome in a way that is simple and efficient, while providing better and more advantageous results.

C. Definitions

“On” pressure—the pressure, measured in psi (pounds per square inch), at which, once exceeded, the system begins to create a suction to remove fluid from the fluid reservoir.

“Off” pressure—the pressure, measured in psi, at which, once reached, the system ceases removing fluid from the fluid reservoir.

Housing—a case or enclosure (as for a mechanical part or an instrument).

Pump—a device that raises, transfers, or compresses fluids or that attenuates gases especially by suction or pressure or both.

Expansion tank—any device utilized to control and maintain the pressure of a fluid in a contained system.

### II. SUMMARY OF THE INVENTION

According to one aspect of the present invention, a pump mechanism pumps fresh cooking oil in an automated fashion.

In accordance with another aspect of the present invention, an expansion tank is used to control the operation of the pump through the pressure switch. The expansion tank will accumulate oil at a rate that is dependant on the on pressure and off pressure. It provides not only a reservoir for the fresh oil, but dampens the pressure effects of the pump and provides for smooth, constant flow of oil.

In accordance with another aspect of the present invention, the pump is switched on and off automatically.

In accordance with another aspect of the present invention, the pumping mechanism is contained within a box that can be placed on a wall or in the ceiling at the back of a restaurant.

In accordance with another aspect of the present invention, better monitoring of oil usage is created.

In accordance with another aspect of the present invention, a method for dispensing fresh cooking oil includes providing an oil reservoir, inserting tubing into the oil reservoir, the tubing being attached to a pump, setting an on pressure to approximately 30 psi, setting an off pressure to approximately 50 psi, setting a pressure relief valve to approximately 75 psi, setting an expansion tank pressure to approximately 30 psi, wherein when the pressure inside the tank reaches the expansion tank pressure, the pump is shut off, turning on the pump, and dispensing fresh cooking oil into an associated fryer.

In accordance with another aspect of the present invention, a fluid dispensing apparatus includes a pump, a motor, the motor operatively connected to the pump, a pressure switch having an on pressure and an off pressure, wherein the off pressure is greater than the on pressure, an expansion tank, an expandable bladder, the expandable bladder operatively connected within the expansion tank, the expandable bladder having a pressure, the pressure being set at approximately the on pressure, tubing, the tubing operatively connected to the pump, and a fluid dispenser.

In accordance with another aspect of the present invention, the pump is at a remote location from the fluid dispenser.

In accordance with another aspect of the present invention, the apparatus further comprises a pressure relief valve.

In accordance with another aspect of the present invention, the pump, the motor, the pressure switch, the expansion tank, and the expandable bladder are located within a housing.

In accordance with another aspect of the present invention, the on pressure is greater than 10 psi and the off pressure is less than 75 psi.

In accordance with another aspect of the present invention, the on pressure is approximately 30 psi and the off pressure is approximately 50 psi.

In accordance with another aspect of the present invention, the pressure relief valve is set at approximately 75 psi.

In accordance with another aspect of the present invention, the apparatus is connected to an associated wall.

In accordance with another aspect of the present invention, the apparatus further comprises tubing and an oil reservoir, the tubing operatively connected to an inlet, the inlet being operatively connected to the pump.

In accordance with another aspect of the present invention, the fluid dispenser dispenses oil into an associated fryer.

In accordance with another aspect of the present invention, the apparatus further comprises a timer relay.

In accordance with another aspect of the present invention, a method for dispensing fluid includes providing a pump, providing a fluid reservoir, inserting tubing into the fluid reservoir, the tubing being operatively connected to the pump, creating a suction force via the pump and tubing, increasing pressure within an expansion tank by drawing fluid from the reservoir, and automatically shutting off the pump when the pressure within the expansion tank reaches a predetermined level.

In accordance with another aspect of the present invention, after the pump has been shut off, decreasing the pressure within the expansion tank by dispensing fluid and automatically turning on the pump when the pressure within the expansion tank reaches a predetermined level.

In accordance with another aspect of the present invention, the process of automatically turning on and/or shutting off the pump can be repeated multiple times.

In accordance with another aspect of the present invention, the predetermined level for shutting off the pump is approximately 50 psi.

In accordance with another aspect of the present invention, the predetermined level for turning the pump back on is approximately 30 psi.

In accordance with another aspect of the present invention, the method further includes providing a pressure relief valve to automatically shut off power when a predetermined pressure is reached and providing a timer relay for preventing the pump from continuous running if the reservoir is empty.

In accordance with another aspect of the present invention, the method is used for dispensing fresh cooking oil from an oil reservoir into an associated fryer.

In accordance with another aspect of the present invention, the pump and expansion tank are located remotely from an associated fryer.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein:

FIG. 1 shows a diagram of the inventive system;

FIG. 2 shows a perspective view of the housing;

FIG. 3 shows another perspective view of the housing;

FIG. 4 shows another perspective view of the housing;

FIG. 5 shows another perspective view of the housing;

FIG. 6 shows another perspective view of the housing;

FIG. 7 shows another perspective view of the housing;

FIG. 8 shows another perspective view of the housing;

FIG. 9 shows another perspective view of the housing;

FIG. 10 shows a plan view of the cover of the housing;

FIG. 11 shows another view of the cover of the housing;

FIG. 12 shows a perspective view of the ear of the housing;

FIG. 13 shows a perspective view of the face of the housing;

FIG. 14 shows a perspective view of the face of the housing;

FIG. 15 shows a perspective view of the base of the housing;

FIG. 16 shows a plane view of the base of the housing;

FIG. 17 shows the inventive system;

FIG. 18 shows a perspective view of the pump and the pressure switch;

FIG. 19 shows a perspective view of the pump;

FIG. 20 shows a perspective view of the pressure switch and the pressure relief valve;

FIG. 21 shows a perspective view of the disconnect fitting and the tubing; and,

FIG. 22 shows a perspective view of the inventive system with a timer relay.

### IV. DESCRIPTION OF THE INVENTION

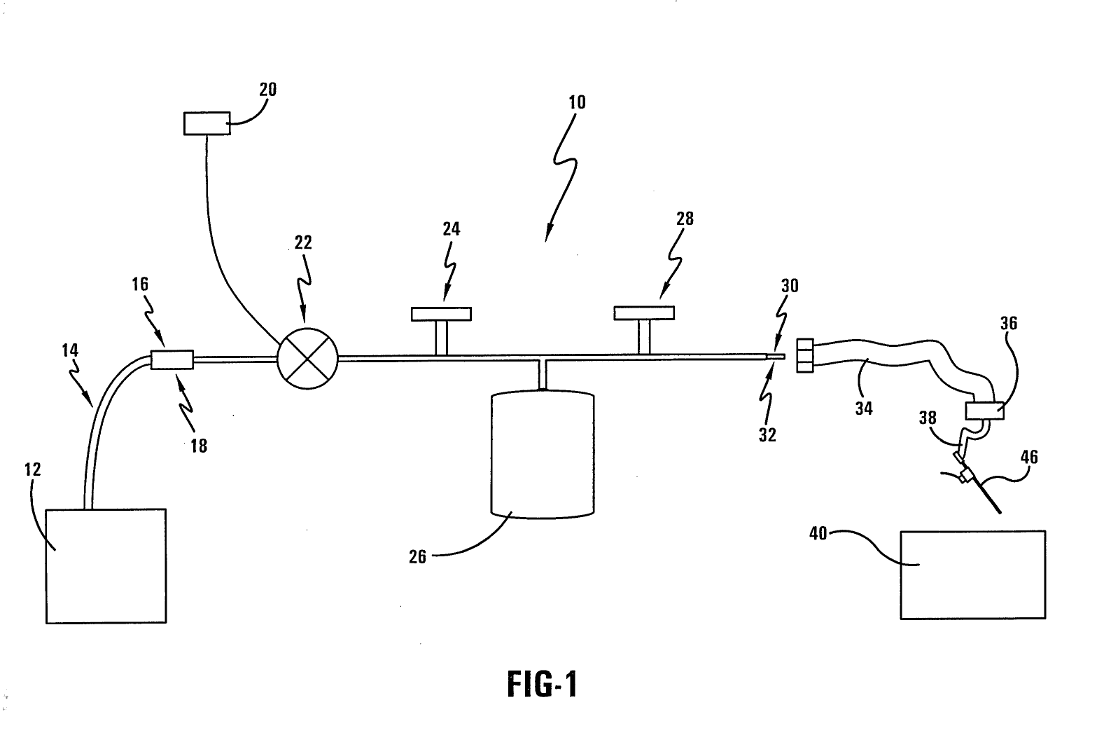

Referring now to at least one embodiment of the invention, FIG. 1 shows an oil dispensing system 10 which includes an oil reservoir 12, tubing 14, an inlet 18 with a disconnect fitting 16, a pump 22 with an on/off switch 20, a pressure switch 24, an expansion tank 26, a pressure relief valve 28, an outlet 32 with a disconnect fitting 30, plumbing tubing 34, a dispensing wand 46 with a disconnect fitting, and a fryer 40. In this embodiment, the tubing 14 is inserted into the oil reservoir 12 to remove the fresh cooking oil. The tubing 14 has an opening at both ends, and at one end has an inlet valve 18 with a disconnect fitting 16. This inlet 18 can be selectively attached and removed from the pump 22. The inlet 18 is attached to the pump 22, which in one embodiment is a five-gallon per minute pump having a ⅓ horsepower motor. The pump 22 has an on/off switch 20. The pump 22 is connected to a pressure switch 24, which is set to a particular pressure. Connected to the pressure switch 24 is an expansion tank 26, which is connected to a pressure relief valve 28. The pressure relief valve 28 can be located outside or inside of the outlet 32, depending on the embodiment. The plumbing tubing 34 is connected to the outlet 32 and the pressure relief valve 28. The disconnect fitting of the wand 46 can be connected to the plumbing tubing 34. It is to be understood that the type of pump 22, tubing 14, 34, inlets 18, outlets 32, motors, expansion tank 26, switches 24, and valves 28 is not intended to be limited by this invention. Any type can be used, as long as chosen using sound engineering judgment.

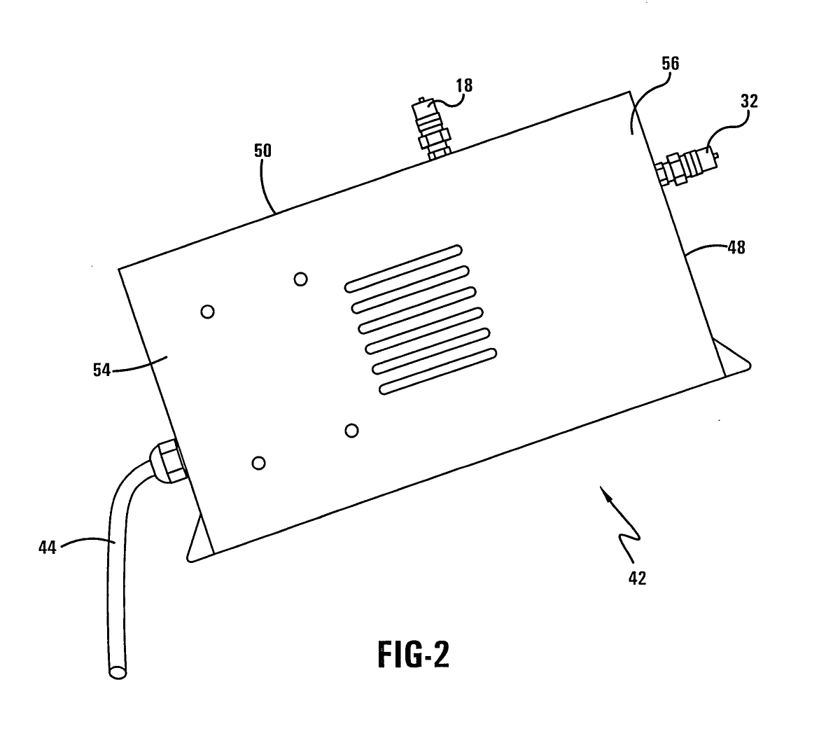

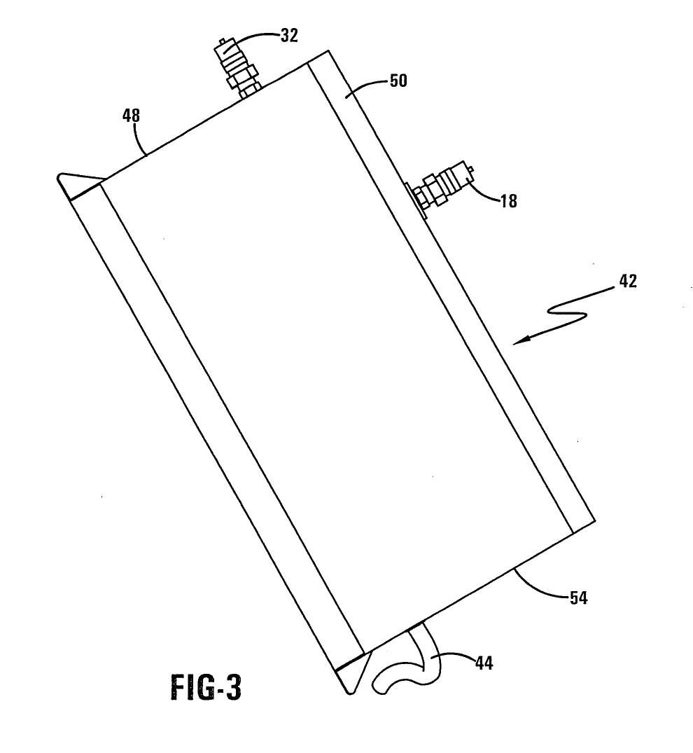

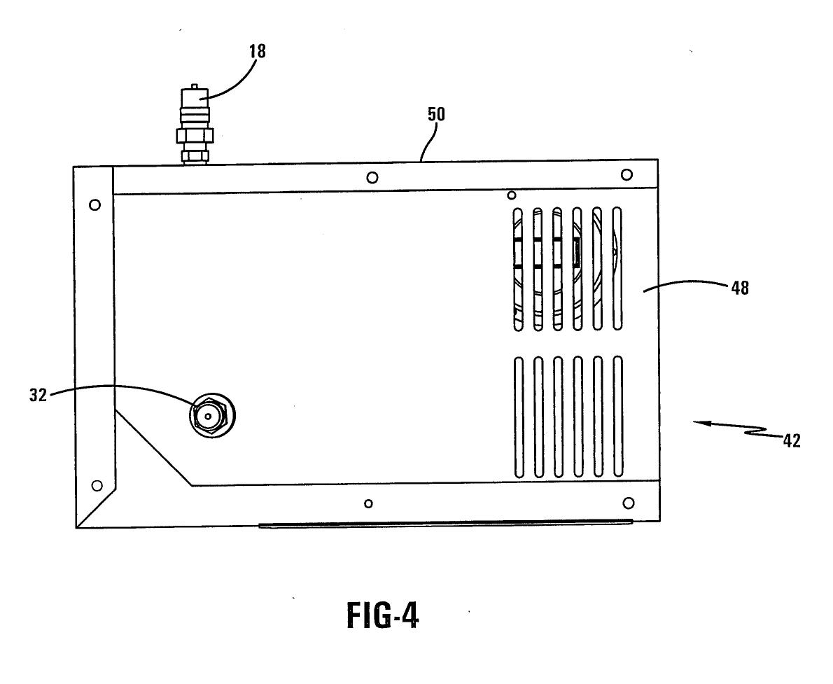

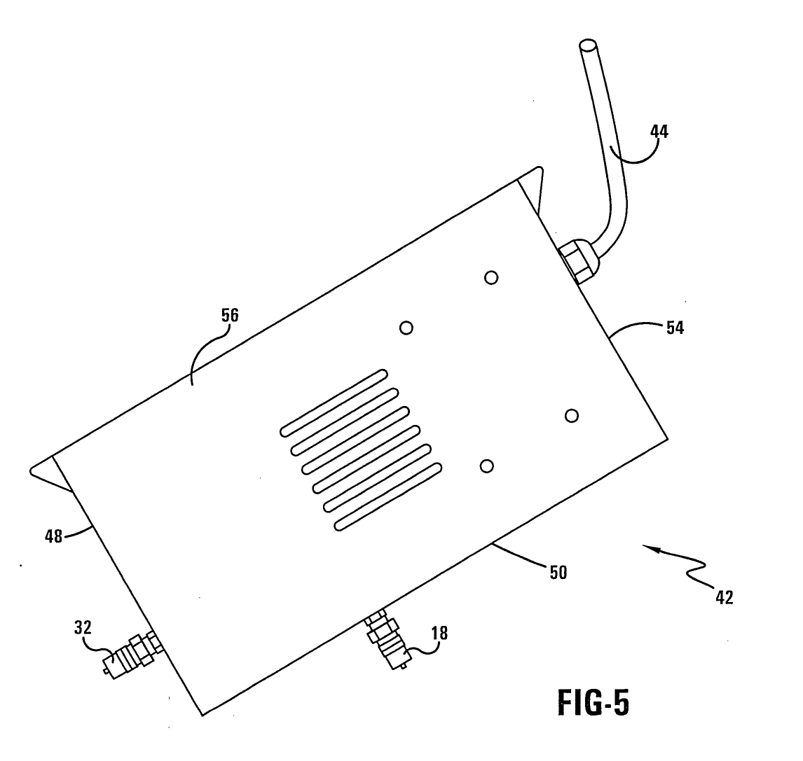

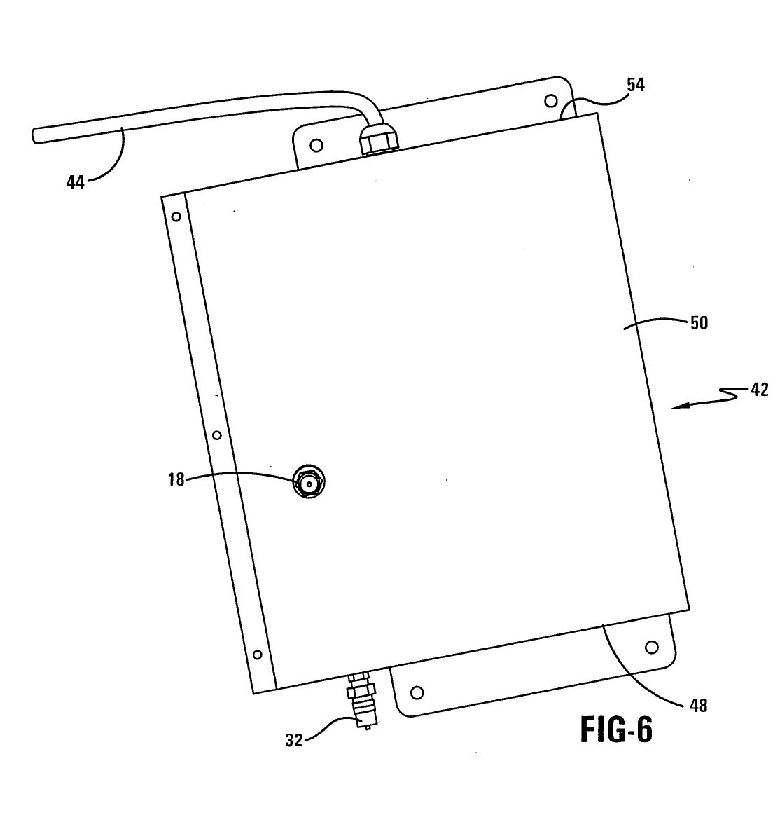

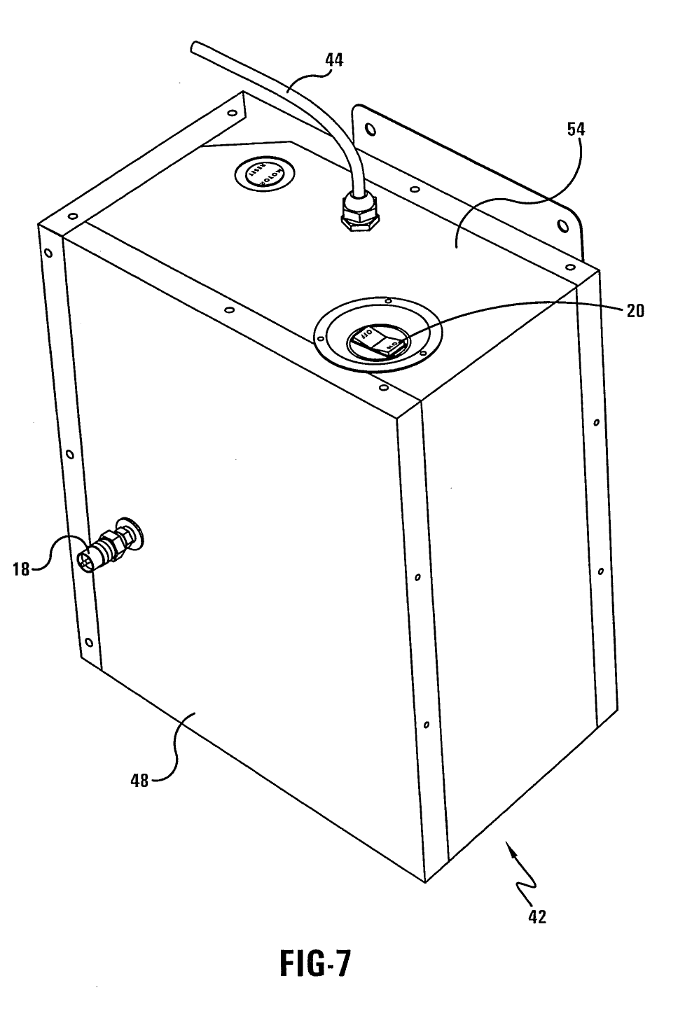

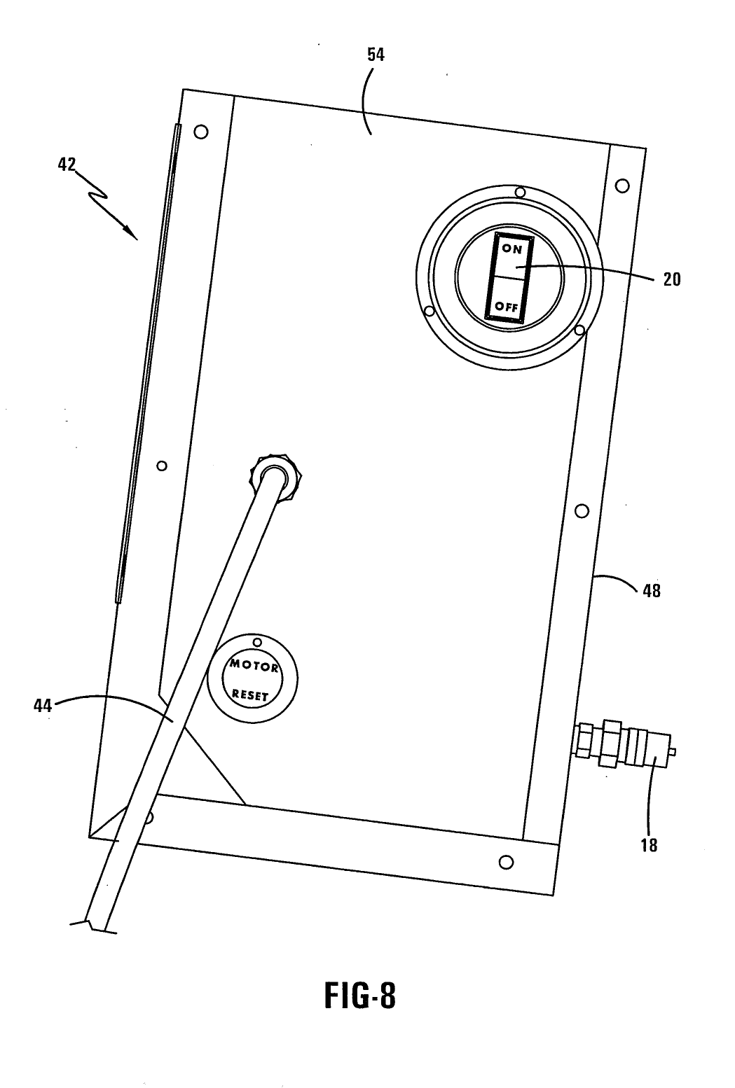

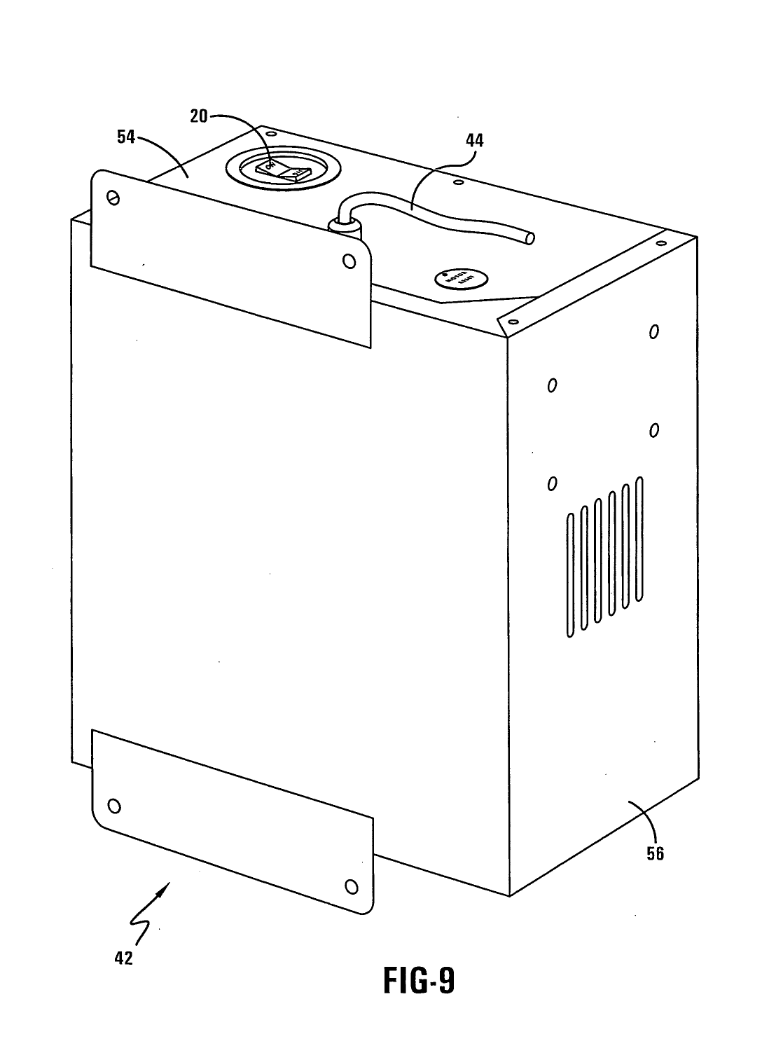

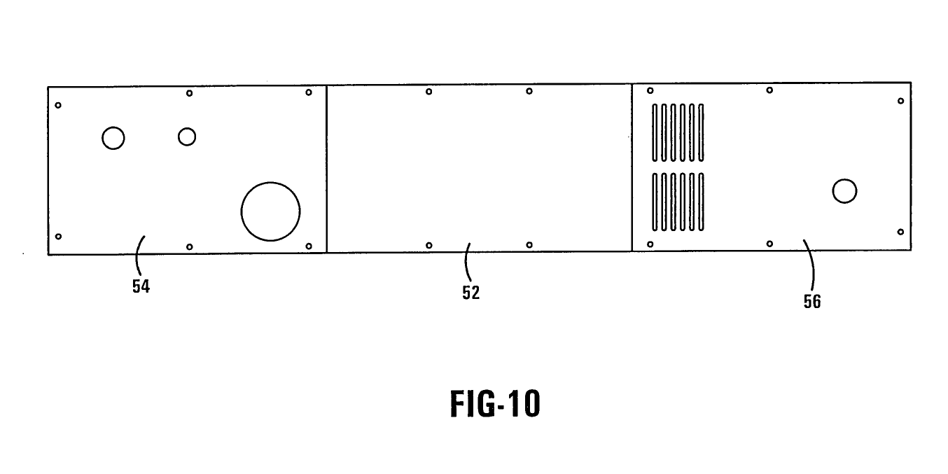

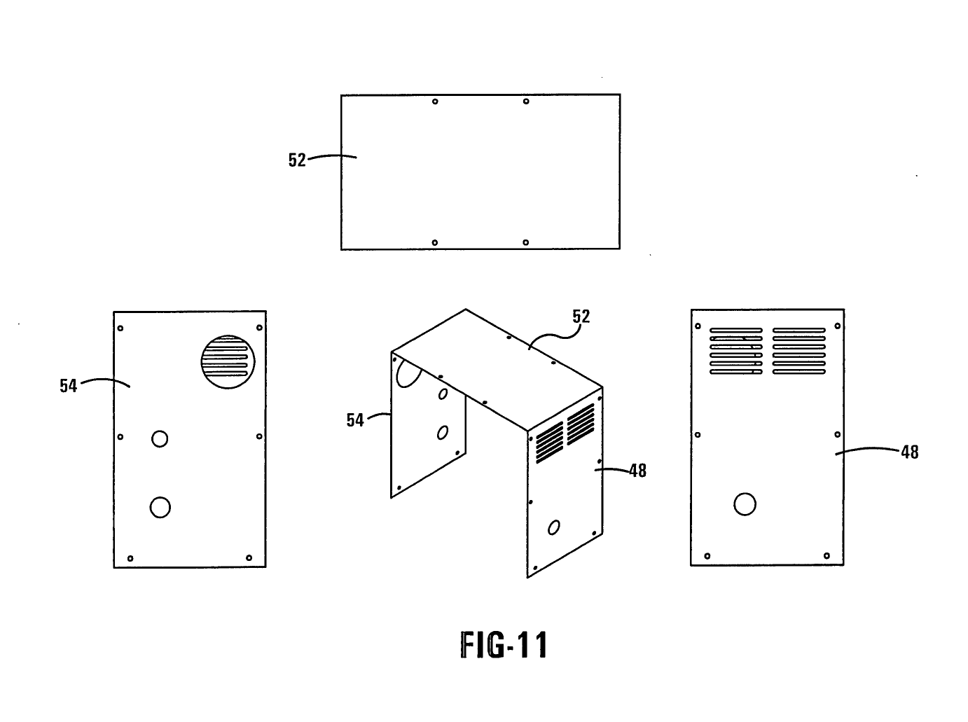

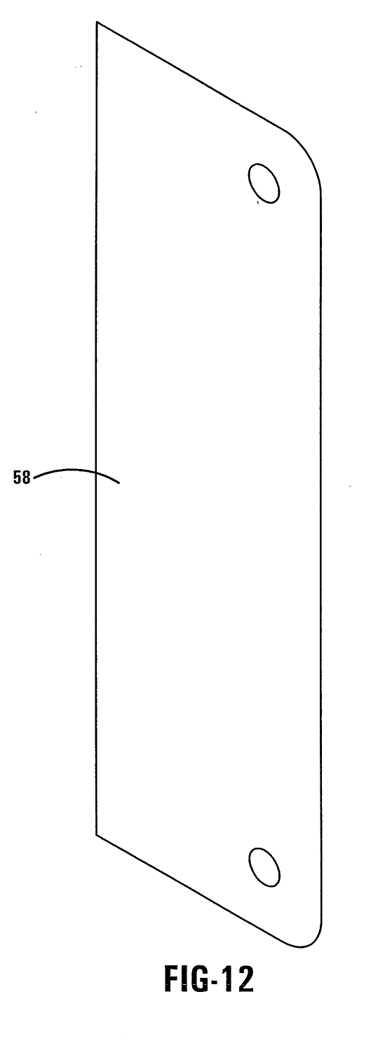

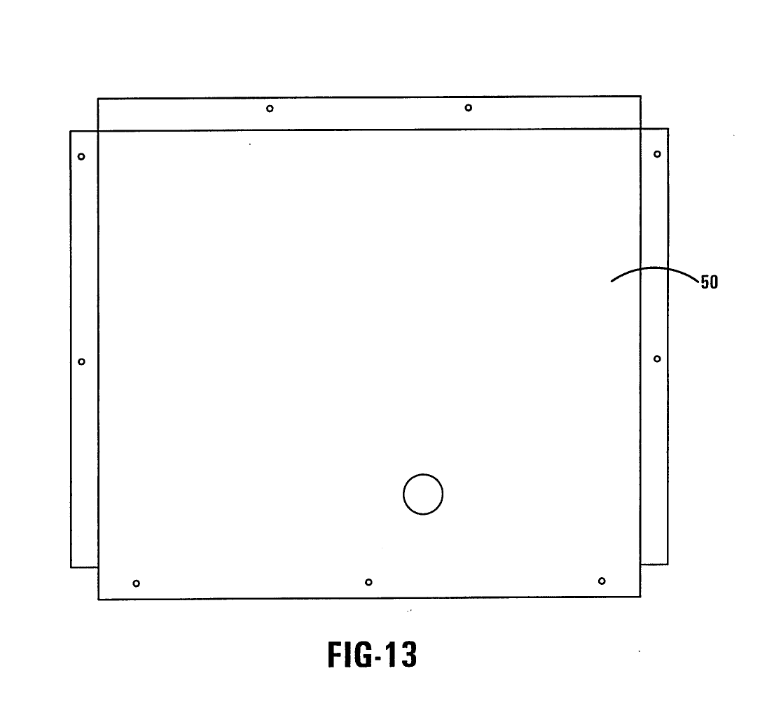

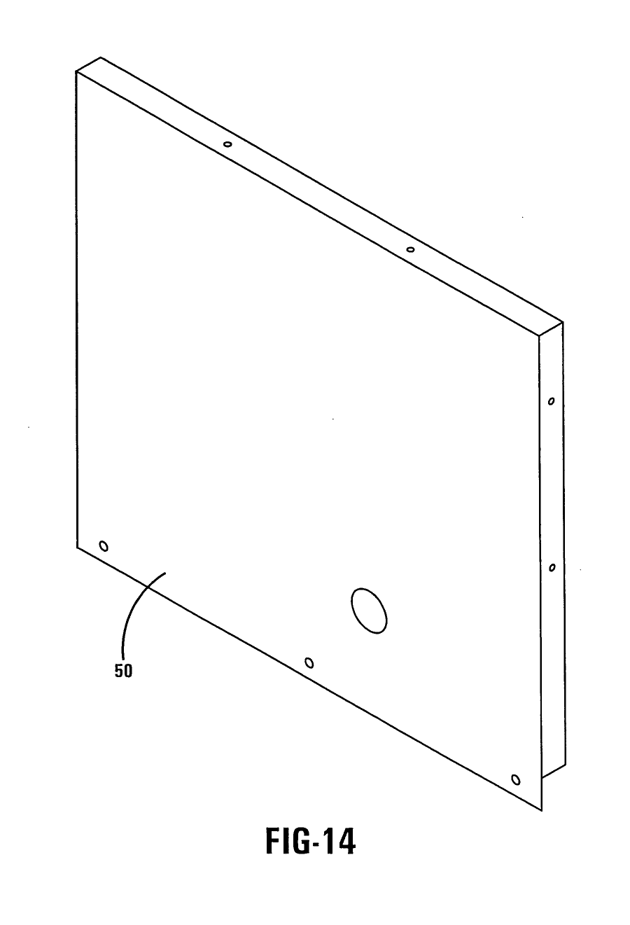

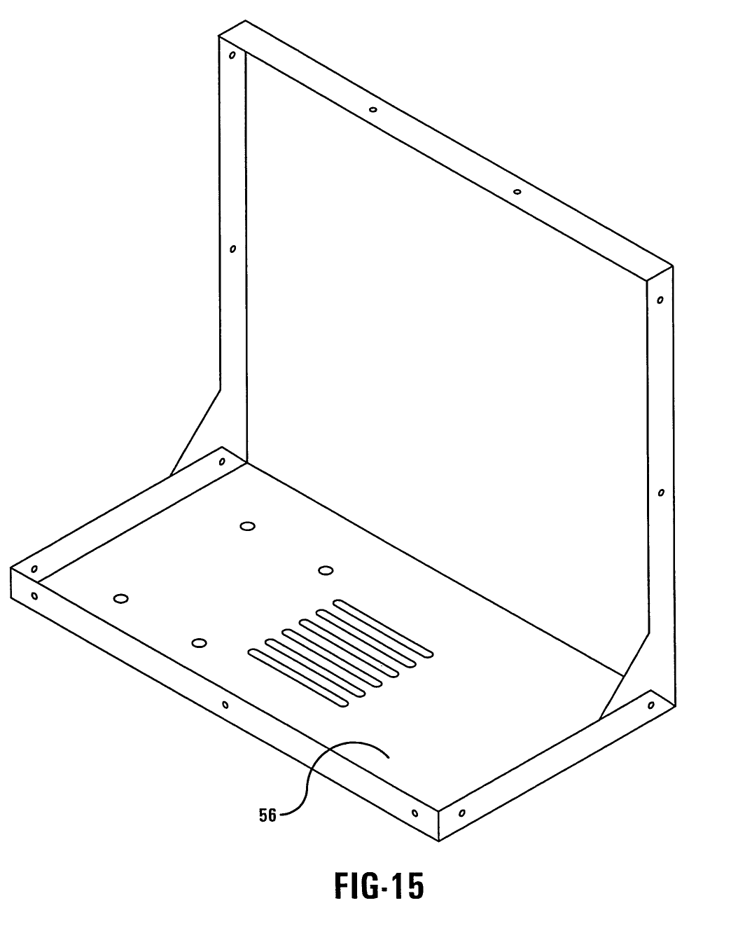

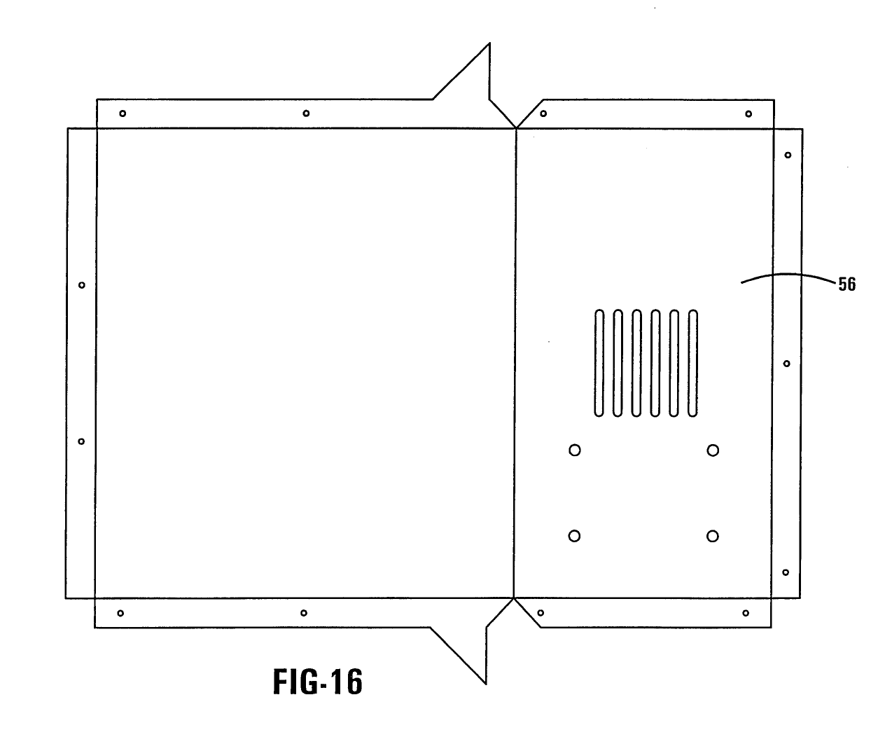

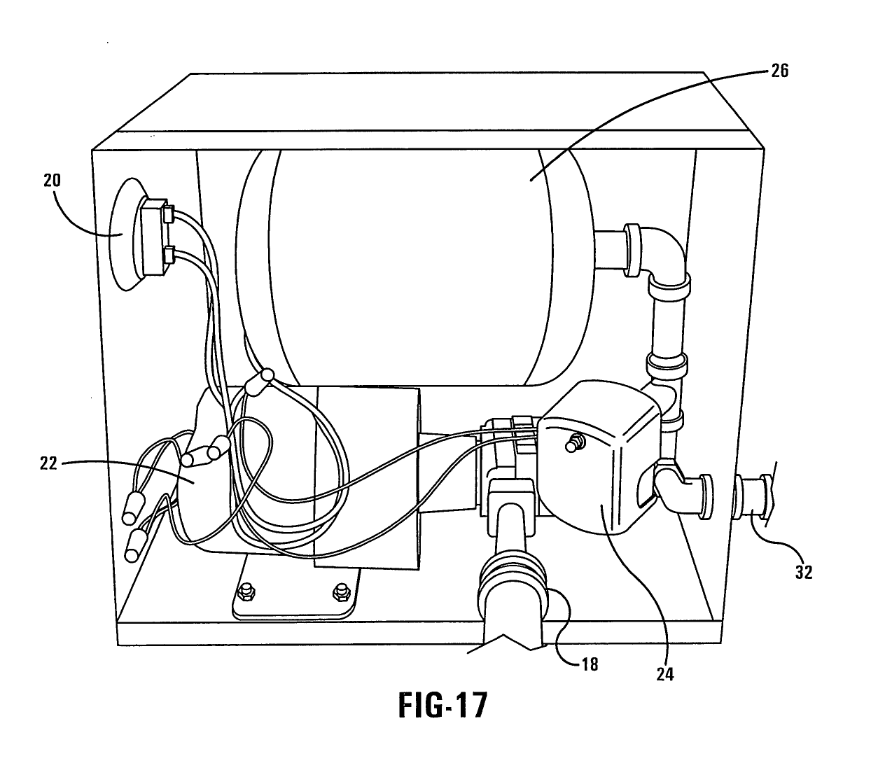

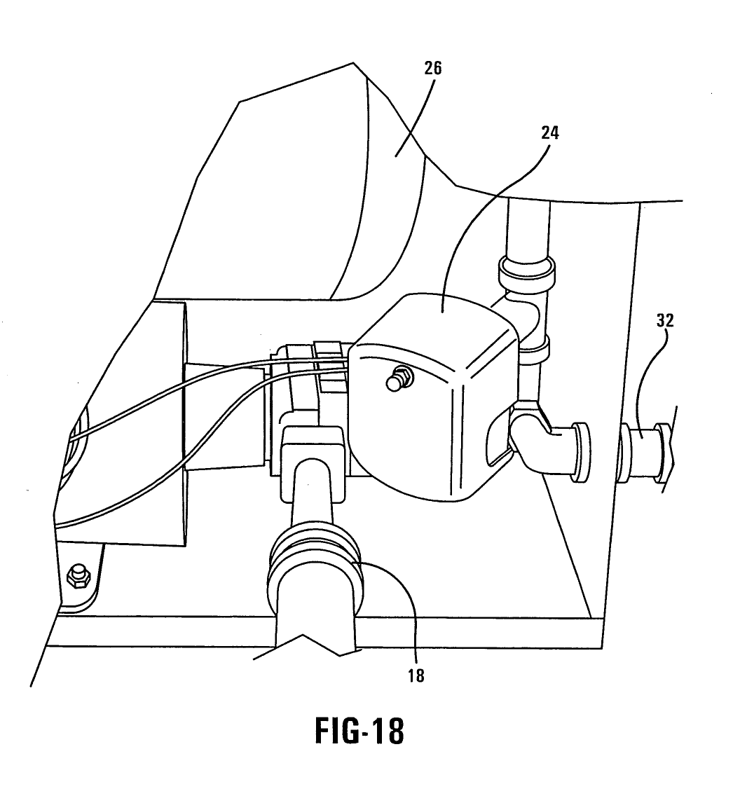

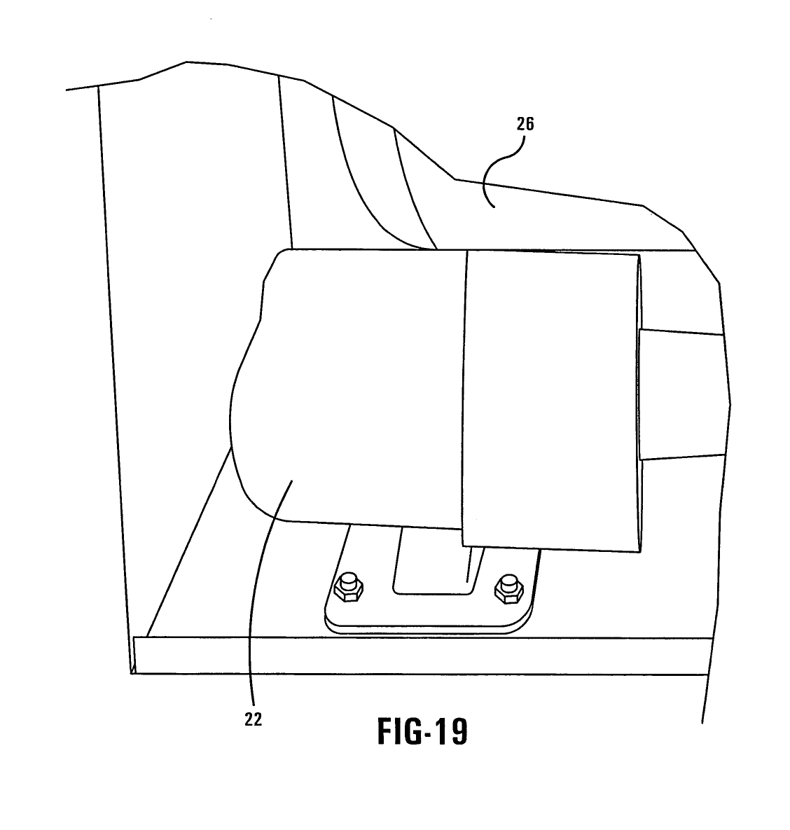

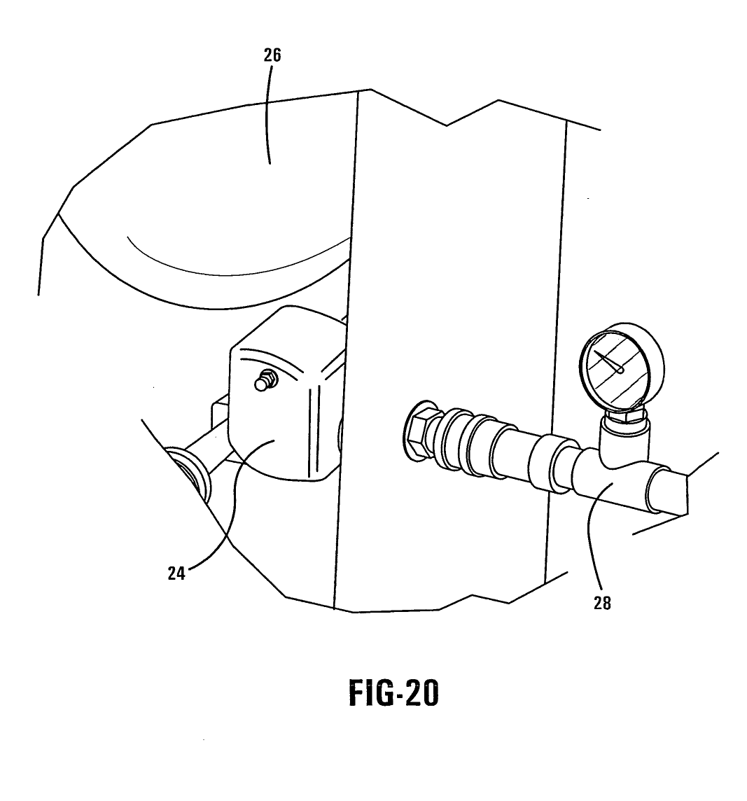

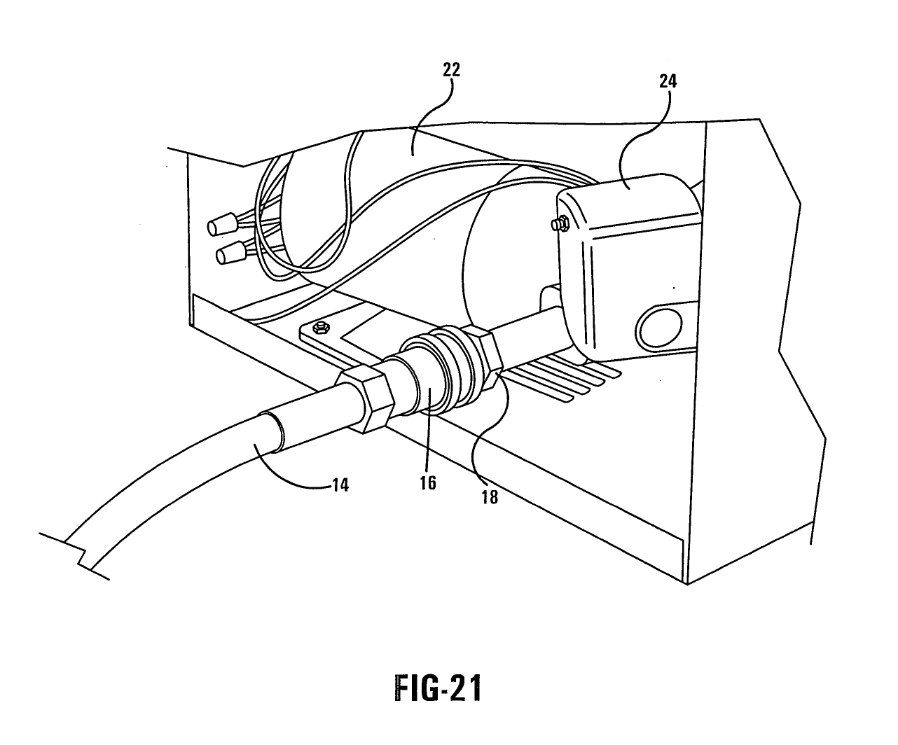

With reference to FIGS. 2-16, the housing 42 of the inventive system 10 is shown. In one embodiment of the invention, the pump 22, motor, pressure switch 24, expansion tank 26, and pressure relief valve 28 are all located within the housing 42. In another embodiment, the pressure relief valve 28 is located outside of the housing 42. Within the housing 42, the pump 22, expansion tank 26, pressure switch 24, and relief valve 28 are connected via tubing 14. The housing 42 ha an outlet side 48, a front 50, a top 52, a switch side 54, a base 56, and an ear 58. In one embodiment, a power cord 44 is attached to the housing 42. With reference now to FIGS. 17-21, the inventive system 10 is shown within the housing 42.

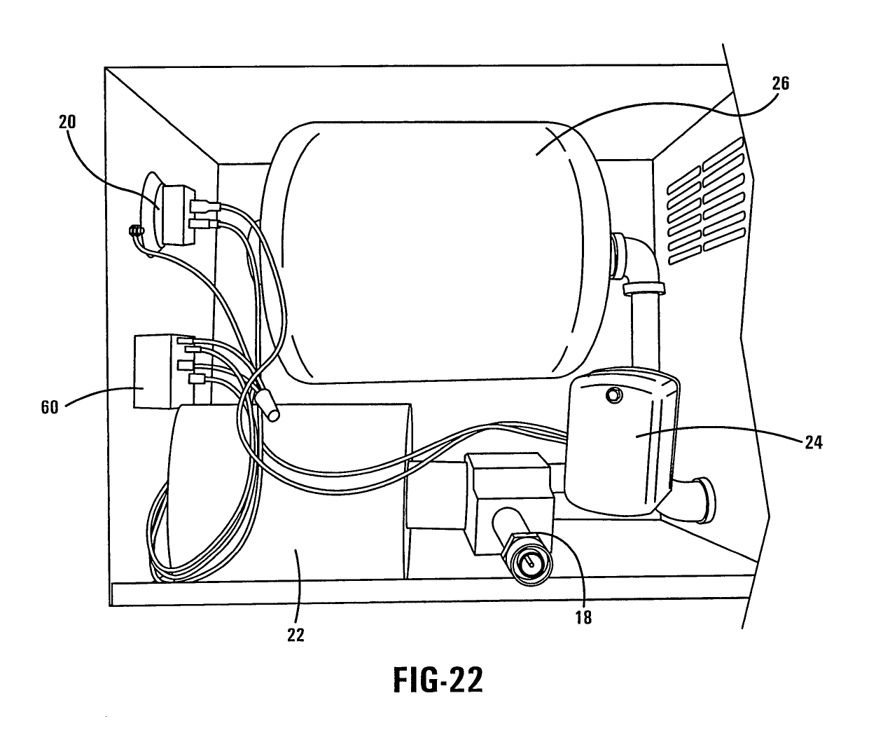

With reference now to FIGS. 1-21, the inventive system 10 is connected to pressurized lines that run through a restaurant, or any other establishment that requires cooking oil. The pumping mechanism, in this embodiment, is located within a housing 42, which is placed on a wall near where the restaurant stores their cooking oil. The tubing 14 extends out to the location of the fryers 40, where the user of the system has a hand-held wand 46 with an on/off trigger (although it is to be understood that any means of dispensing the oil may be used, as long as chosen using sound engineering judgment) that allows the easy, efficient dispensing of the fresh cooking oil. In one embodiment, as shown in FIG. 22, a timer relay 60 prevents the pump 22 from running forever should the oil supply be empty or if a supply pipe burst. The relay 60 goes between the on/off switch 20 and the pressure switch 24. If a pipe leaks, the wand 46 malfunctions, or some other problem that would cause a pressure/liquid leak, the relay 60 will automatically shut off the pump 22 after a specific period of time. The timer relay 60 can be set to any time desired by the user, as long as chosen using sound engineering judgment. In order to restart the pump 22, the on/off switch 20 is cycled to reset the relay 60. The operator would notice that the system 10 had stopped pumping, see the leak, and have the system 10 repaired prior to turning the pump 22 on again. For normal operations, without problems, the relay 60 resets itself every time the pressure reaches the “off” pressure. This eliminates the need to manually reset the system 10, unless there is a problem.

The process begins with a certain amount of oil located in an oil reservoir 12. The pressure switch 24 is set to a particular “on” pressure and a particular “off” pressure, which in one embodiment is 30 psi and 50 psi, respectively. The pressure relief valve 28, which is used to prevent an explosion if too much pressure is built up, is set at a level above the “off” pressure. In this embodiment, the pressure relief valve 28 is set at 75 psi. The expansion tank 26 is set at approximately the pressure of the “on” pressure, so in one embodiment would be 30 psi. The tubing 14 is placed into the oil reservoir 12 and the pumping mechanism 22 is turned on. The pump 22 sucks the oil through the tubing 14 into the expansion tank 26. In this embodiment, the inside of the expansion tank 26 has an expandable bladder (not shown) that expands as the tank 26 is filled with oil. When the expanding bladder creates pressure within the tank 26 at 50 psi, or whatever the “off” pressure is set to, the pump 22 is automatically shut off. Once the pump 22 has been shut off, the oil is ready to be dispensed. In order to dispense the oil, the on/off trigger on the wand 46 is depressed and the oil flows into the fryer 40. As the oil is flowing from the expansion tank 26, the bladder is contracting, and the pressure within the tank 26 is decreasing. When the pressure in the tank 26, as measured by the pressure switch 24, reaches 30 psi (or whatever the “on” pressure is set to) the pump 22 is automatically turned back on, and more oil is sucked from the oil reservoir 12. In this manner, the inventive system 10 allows the user to have a continual flow of oil from the reservoir 12 to the fryer 40, without the need to manually turn on and off the pump 22.

Although the previous embodiment has been described in terms of cooking oil, it is to be understood that the inventive system 10 could be used in the dispensing of any type of fluid. It is also to be understood that the materials from the which the tubing, housing, wand, pipes, and the other components are made is not critical to the invention, and any material, chosen using sound engineering judgment can be used. The disconnect fittings at the inlet, outlet, and wand allow the various components to be detached as necessary, but are not critical to the invention. It is also to be understood that the on and off pressures can be any pressure chosen using sound engineering judgment.

At least one embodiment has been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A method for dispensing fresh cooking oil, the method comprising the steps of:
providing an oil reservoir;
inserting tubing into the oil reservoir, the tubing being attached to a pump;
setting an on pressure to approximately 30 psi;
setting an off pressure to approximately 50 psi;
setting a pressure relief valve to approximately 75 psi;
setting an expansion tank pressure to approximately 30 psi, wherein when the pressure inside the tank reaches the expansion tank pressure, the pump is shut off;
turning on the pump; and,
dispensing fresh cooking oil into an associated fryer.

2. A fluid dispensing apparatus comprising:
a pump;
a motor, the motor operatively connected to the pump;
a pressure switch having an on pressure and an off pressure, wherein the off pressure is greater than the on pressure;
an expansion tank;
an expandable bladder, the expandable bladder operatively connected within the expansion tank, the expandable bladder having a pressure, the pressure being set at approximately the on pressure;
tubing, the tubing operatively connected to the pump; and,
a fluid dispenser.

3. The apparatus of claim 2, wherein the pump is at a remote location from the fluid dispenser.

4. The apparatus of claim 2, wherein the apparatus further comprises a pressure relief valve.

5. The apparatus of claim 2, wherein the pump, the motor, the pressure switch, the expansion tank, and the expandable bladder are located within a housing.

6. The apparatus of claim 2, wherein the on pressure is greater than 10 psi and the off pressure is less than 75 psi.

7. The apparatus of claim 6, wherein the on pressure is approximately 30 psi and the off pressure is approximately 50 psi.

8. The apparatus of claim 4, wherein the pressure relief valve is set at approximately 75 psi.

9. The apparatus of claim 3, wherein the apparatus is connected to an associated wall.

10. The apparatus of claim 9, wherein the apparatus further comprises:
tubing; and,
an oil reservoir, the tubing operatively connected to an inlet, the inlet being operatively connected to the pump.

11. The apparatus of claim 10, wherein the fluid dispenser dispenses oil into an associated fryer.

12. The apparatus of claim 8, wherein the apparatus further comprises a timer relay.

13. A method for dispensing fluid, the method comprising the steps of:
providing a pump;
providing a fluid reservoir;
inserting tubing into the fluid reservoir, the tubing being operatively connected to the pump;
creating a suction force via the pump and tubing;
increasing pressure within an expansion tank by drawing fluid from the reservoir; and,
automatically shutting off the pump when the pressure within the expansion tank reaches a predetermined level.

14. The method of claim 13, wherein the method further comprises the steps of:
after the pump has been shut off, decreasing the pressure within the expansion tank by dispensing fluid; and,
automatically turning on the pump when the pressure within the expansion tank reaches a predetermined level.

15. The method of claim 14, wherein the process of automatically turning on and/or shutting off the pump can be repeated multiple times.

16. The method of claim 15, wherein the predetermined level for shutting off the pump is approximately 50 psi.

17. The method of claim 16, wherein the predetermined level for turning the pump back on is approximately 30 psi.

18. The method of claim 13, wherein the method further comprises the steps of:
providing a pressure relief valve to automatically shut off power when a predetermined pressure is reached; and,
providing a timer relay for preventing the pump from continuous running if the reservoir is empty.

19. The method of claim 13, wherein the method is used for dispensing fresh cooking oil from an oil reservoir into an associated fryer.

20. The method of claim 14, wherein the pump and expansion tank are located remotely from an associated fryer.
